(19) United States
(12) Patent Application Publication
(10) Pub. No.: US 2013/0221733 A1
(43) Pub. Date: Aug. 29, 2013

(54) Brake Control Apparatus

(71) Applicant: HITACHI AUTOMOTIVE SYSTEMS, LTD., (US)

(72) Inventor: Atsushi MATSUOKA, Hadano-shi (JP)

(73) Assignee: HITACHI AUTOMOTIVE SYSTEMS, LTD., Hitachinaka-shi (JP)

(21) Appl. No.: 13/733,426

(22) Filed: Jan. 3, 2013

(30) Foreign Application Priority Data
Feb. 27, 2012 (JP) 2012-039508

(51) Int. Cl. B60T 13/58; B60T 13/14

(52) U.S. Cl. CPC B60T 13/586; B60T 13/145
USPC 303/3; 303/10

(57) ABSTRACT

A brake control apparatus includes a first brake fluid passage connecting a master cylinder to a wheel cylinder. A second brake fluid passage is connected to the first brake fluid passage. A first pump pressurizes brake fluid from the master cylinder and sends the pressurized brake fluid to the wheel cylinder through the second brake fluid passage. A third brake fluid passage is branched from the first brake fluid passage, and connected to the first pump. A fourth brake fluid passage is branched from the third brake fluid passage, and connected to the first brake fluid passage. A pressure regulator reservoir is disposed in the fourth brake fluid passage. A second pump sends brake fluid from the pressure regulator reservoir to the wheel cylinder by discharging to the first brake fluid passage.

### BACKGROUND OF THE INVENTION

The present invention relates to brake control apparatuses.

Japanese Patent Application Publication 10-203338 discloses a brake control apparatus which implements a brake boost function by pressurizing brake fluid with a pump, which brake fluid is stored in and supplied from a reservoir tank.

### SUMMARY OF THE INVENTION

The brake control apparatus described above is of a brake-by-wire type in which a braking input section and a braking output section are connected to each other by electrical signal communication, wherein the braking input section includes a brake pedal, and the braking output section includes a wheel brake. The brake-by-wire type is usually provided with a failsafe system for cases of electrical failure. For example, the failsafe system includes a mechanical brake system for generating braking force, and redundant power supplies. This complexity of structure tends to increase the manufacturing cost.

In view of the foregoing, it is desirable to provide a brake control apparatus capable of performing a similar boost function with a simpler structure. It is also desirable to provide such a brake control apparatus based on an existing hydraulic pressure control unit.

According to one aspect of the present invention, a brake control apparatus comprises: a first brake fluid passage hydraulically connecting a master cylinder to a wheel cylinder, wherein the master cylinder generates a brake fluid pressure in response to driver's braking operation, and wherein the brake fluid pressure acts on the wheel cylinder; a second brake fluid passage hydraulically connected to a connecting portion of the first brake fluid passage; a first pump configured to pressurize brake fluid from the master cylinder and send the pressurized brake fluid to the wheel cylinder through the second brake fluid passage; a third brake fluid passage branched from a branch portion of the first brake fluid passage, and hydraulically connected to the first pump; a fourth brake fluid passage branched from a branch portion of the third brake fluid passage, and hydraulically connected to the first brake fluid passage; a pressure regulator reservoir disposed in the fourth brake fluid passage; and a second pump configured to send brake fluid from the pressure regulator reservoir to the wheel cylinder by discharging to the first brake fluid passage.

According to another aspect of the present invention, a brake control apparatus for a vehicle provided with a regenerative braking system, the brake control apparatus comprises: a braking operation detecting section configured to detect a condition of driver's braking operation; a regenerative braking operation detecting section configured to detect a condition of regenerative braking operation of the regenerative braking system; a first brake fluid passage hydraulically connecting a master cylinder to a wheel cylinder; a second brake fluid passage hydraulically connected to a connecting portion of the first brake fluid passage; a first pump configured to pressurize brake fluid from the master cylinder and send the pressurized brake fluid to the wheel cylinder through the second brake fluid passage; a third brake fluid passage branched from a branch portion of the first brake fluid passage, and hydraulically connected to a suction side of the first pump; a fourth brake fluid passage branched from a branch portion of the third brake fluid passage, and hydraulically connected to the first brake fluid passage; a pressure regulator reservoir disposed in the fourth brake fluid passage; a second pump disposed in parallel with the first pump, and configured to discharge brake fluid from the pressure regulator reservoir to the first brake fluid passage; and a control unit configured to control operation of the first pump and the second pump, based on the detected condition of driver's braking operation and the detected condition of regenerative braking operation. The brake control apparatus may further comprise: a gate-out valve disposed in a section of the first brake fluid passage between the master cylinder and the connecting portion of the first brake fluid passage from which the second brake fluid passage is hydraulically connected, wherein the gate-out valve is a normally open valve; a solenoid in-valve disposed in a section of the first brake fluid passage between the wheel cylinder and the gate-out valve, wherein the solenoid in-valve is a normally open valve; a fifth brake fluid passage hydraulically connecting the wheel cylinder to the pressure regulator reservoir; and a solenoid out-valve disposed in the fifth brake fluid passage, wherein the solenoid out-valve is a normally closed valve. The brake control apparatus may further comprise a pressure regulator valve disposed in the third brake fluid passage, and configured to shut off brake fluid flow from the first brake fluid passage to the first pump resulting from brake fluid pressure generated by the master cylinder, wherein the branch portion of the third brake fluid passage from which the fourth brake fluid passage is branched is disposed between the pressure regulator valve and the branch portion of the first brake fluid passage from which the third brake fluid passage is branched. The brake control apparatus may further comprise: a first motor configured to drive the first pump; and a second motor configured to drive the second pump; wherein the control unit is configured to control the gate-out valve, the solenoid in-valve, the solenoid out-valve, the first motor, and the second motor. The brake control apparatus may be configured so that the control unit includes a brake feel producing section configured to send a quantity of brake fluid under pressure to the pressure regulator reservoir by operating the gate-out valve in a closing direction, operating the solenoid out-valve in an opening direction, and driving the first motor, wherein the quantity of brake fluid is flown out of the master cylinder by driver's braking operation. The brake control apparatus may be configured so that the control unit includes a cooperative regenerative braking control section configured to send a quantity of brake fluid under pressure to the pressure regulator reservoir and the wheel cylinder by operating the gate-out valve in the closing direction, operating the solenoid out-valve in a closing direction, and driving the first motor, wherein the quantity of brake fluid is flown out of the master cylinder by driver's braking operation. The brake control apparatus may be configured so that the control unit includes a wheel cylinder pressure reduction control section configured to allow brake fluid to flow out from the wheel cylinder to the pressure regulator reservoir by operating the solenoid out-valve in the opening direction. The brake control apparatus may be configured so that the control unit includes a wheel cylinder pressure increase control section configured to send brake fluid under pressure from the pressure regulator reservoir to the wheel cylinder by operating the solenoid out-valve in the closing direction and driving the second motor. The brake control apparatus may be configured so that the control unit includes a wheel cylinder pressure quick increase control section configured to pressurize the wheel cylinder by driving the first motor and driving the second motor.

According to a further aspect of the present invention, a brake control apparatus for a vehicle provided with a regenerative braking system, the brake control apparatus comprises: a braking operation detecting section configured to detect a condition of driver's braking operation; a regenerative braking operation detecting section configured to detect a condition of regenerative braking operation of the regenerative braking system; a first brake fluid passage hydraulically connecting a master cylinder to a wheel cylinder; a second brake fluid passage hydraulically connected to a connecting portion of the first brake fluid passage; a first pump configured to pressurize brake fluid from the master cylinder and send the pressurized brake fluid to the wheel cylinder through the second brake fluid passage; a third brake fluid passage branched from a branch portion of the first brake fluid passage, and hydraulically connected to a suction side of the first pump; a fourth brake fluid passage branched from a branch portion of the third brake fluid passage, and hydraulically connected to the first brake fluid passage; a pressure regulator reservoir disposed in the fourth brake fluid passage; a second pump disposed in parallel with the first pump, and configured to discharge brake fluid from the pressure regulator reservoir to the first brake fluid passage; and a control unit configured to control operation of the first pump and the second pump, based on the detected condition of driver's braking operation and the detected condition of regenerative braking operation; wherein the control unit includes: a hard braking control section configured to pressurize the wheel cylinder by driving the first motor and driving the second motor; a brake feel producing section configured to produce a brake operation feel by driving the first motor under condition that the regenerative braking system is producing a braking force; a wheel cylinder pressure reduction control section configured to reduce pressure of the wheel cylinder in response to increase of the braking force produced by the regenerative braking system, without driving the driving the first and second motors; and a wheel cylinder pressure increase control section configured to pressurize the wheel cylinder by driving the second motor in response to decrease of the braking force produced by the regenerative braking system.

### BRIEF DESCRIPTION OF THE DRAWINGS

FIG. 1 is a schematic diagram showing a brake system of a motor vehicle provided with a brake control apparatus according to a first embodiment of the present invention.

FIG. 2 is a schematic diagram showing a hydraulic circuit of the brake control apparatus.

FIG. 3 is a control block diagram showing a function of cooperative regenerative braking control of a brake control unit of the brake control apparatus.

FIGS. 4A and 4B are time charts showing how three kinds of braking force (driver request braking force, regenerative braking force and frictional braking force (or hydraulic braking force)) change with time during a period of time from a time instant when a brake pedal starts to be depressed down by a driver to a time instant when a vehicle comes to a halt.

FIG. 5 is a schematic diagram showing how a hydraulic pressure control unit operates and brake fluid flows in the hydraulic circuit at a beginning of braking operation.

FIG. 6 is a schematic diagram showing how the hydraulic pressure control unit operates and brake fluid flows in the hydraulic circuit at a stage of increase of braking force.

FIG. 7 is a schematic diagram showing how the hydraulic pressure control unit operates and brake fluid flows in the hydraulic circuit at a stage of increase of regenerative braking force.

FIG. 8 is a schematic diagram showing how the hydraulic pressure control unit operates and brake fluid flows in the hydraulic circuit at a stage of termination of regenerative braking operation.

FIG. 9 is a schematic diagram showing how the hydraulic pressure control unit operates and brake fluid flows in the hydraulic circuit at a stage of hard braking operation.

FIG. 10 is a schematic diagram showing a hydraulic circuit of a brake control apparatus according to a second embodiment of the present invention.

FIG. 11 is a control block diagram showing a function of cooperative regenerative braking control of a brake control unit of a brake control apparatus according to a third embodiment of the present invention.

FIG. 12 is a schematic diagram showing a first part of a hydraulic circuit of a brake control apparatus according to a fourth embodiment of the present invention.

FIG. 13 is a schematic diagram showing a second part of the hydraulic circuit of the brake control apparatus according to the fourth embodiment.

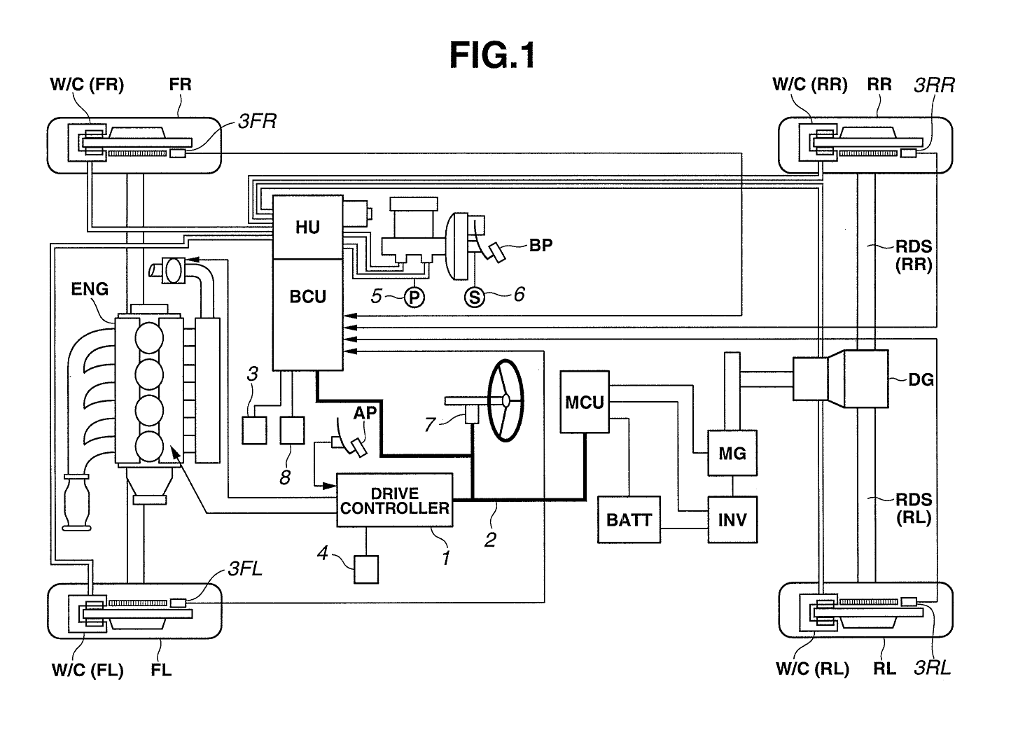

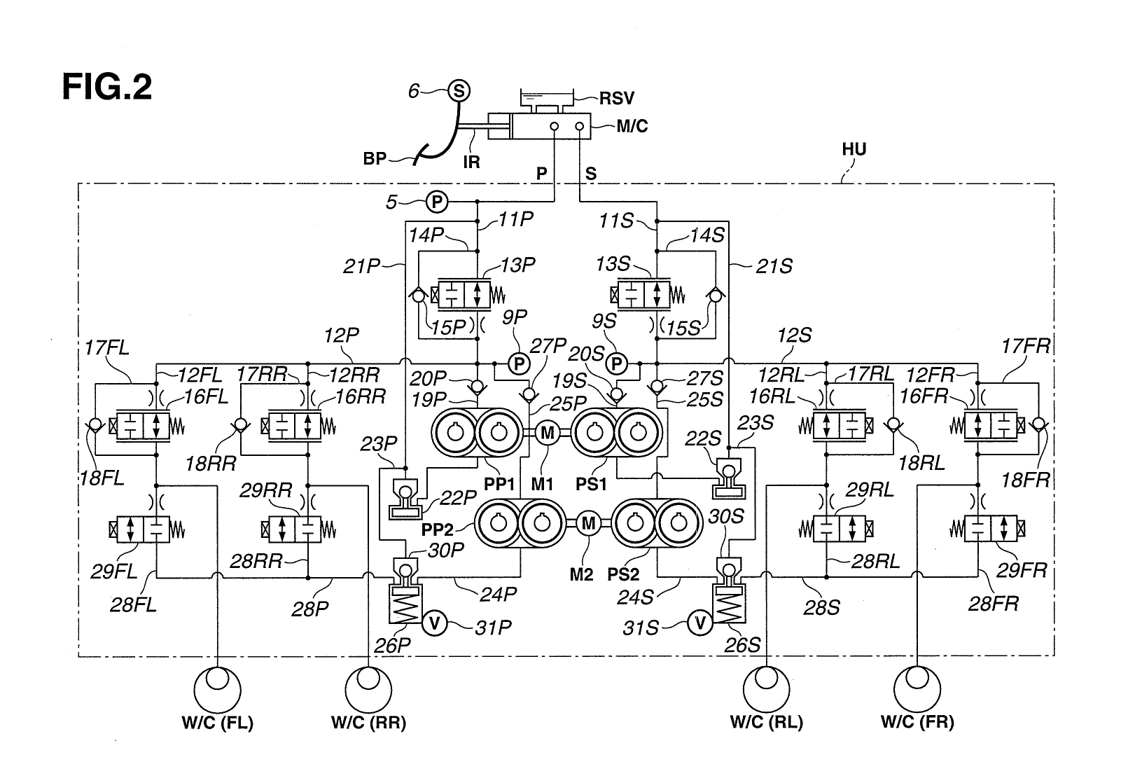

### DETAILED DESCRIPTION OF THE INVENTION

<First Embodiment> FIG. 1 schematically shows a brake system of a motor vehicle provided with a brake control apparatus according to a first embodiment of the present invention. FIG. 2 schematically shows a hydraulic circuit of the brake control apparatus.

<System Configuration> In response to a command signal from a brake control unit BCU, a hydraulic pressure control unit HU increases or reduces or holds the internal pressure of each of a left front wheel cylinder W/C(FL) at a left front road wheel FL, a right front wheel cylinder W/C(FR) at a right front road wheel FR, a left rear wheel cylinder W/C(RL) at a left rear road wheel RL, and a right rear wheel cylinder W/C(RR) at a right rear road wheel RR.

A motor generator MG is a three-phase alternating-current motor. Motor generator MG is coupled to a left rear drive shaft RDS(RL) for left rear road wheel

RL and a right rear drive shaft RDS(RR) for right rear road wheel RR through a differential gear DG. Motor generator MG rotates in power run state or in regeneration run state, and applies to left and right rear road wheels RL, RR driving forces or regenerative braking forces, depending on a command from a motor control unit MCU.

An inverter INV receives a command signal from motor control unit MCU, and performs based on the command signal a conversion to an alternating current from a direct current supplied from a battery BATT, and supplies the converted current to motor generator MG so that motor generator MG rotates under power. On the other hand, in response to a command signal from motor control unit MCU, inverter INV allows motor generator MG to run in regenerative mode, by performing a conversion to a direct current from an alternating current generated at motor generator MG, and supplying the converted current to battery BATT for charging the same.

Motor control unit MCU receives a command signal from a drive controller 1, and outputs to inverter INV a command signal that is generated depending on the received command signal. In response to a command signal from brake control unit BCU, motor control unit MCU outputs a command signal to inverter INV. Motor control unit MCU sends information to brake control unit BCU and drive controller 1 through a communication line 2, wherein the information includes a condition of output control of driving torque or regenerative braking torque of motor generator MG, and an upper limit of regenerative braking torque generated by motor generator MG (or an upper limit of regenerative braking force at road wheels). This upper limit may be calculated based on an estimated value of a battery SOC (state of charge) which is obtained with reference to the terminal voltage and current of battery BATT, and based on an estimated or calculated value of vehicle body speed or vehicle speed. When the vehicle is turning, the upper limit may be calculated in account of steer characteristics of the vehicle. Specifically, when the battery SOC is at or close to a full level, the upper limit is set in consideration of preventing the battery BATT from being overcharged, and thereby protecting the battery BATT. When the vehicle is decelerated by braking, the maximum possible value of regenerative braking force decreases as the vehicle speed decreases. On the other hand, when the vehicle is traveling at high speed, regenerative braking operation may cause a high load applied to inverter INV. In view of the foregoing, the upper limit of regenerative braking force is set for protection of inverter INV.

The setting of the upper limit of regenerative braking force is further advantageous as follows. In the case of the vehicle according to this embodiment, regenerative braking torque is applied to the rear wheels. If the regenerative braking force is excessively higher than the frictional braking force when the vehicle is turning, namely, if the total braking force of rear wheels is excessively higher than the total braking force of front wheels, the vehicle may be fall in oversteer tendency, so that turning behavior of the vehicle may become unstable. In such situations, it is desirable to conform braking force distribution between the front side and the rear side during turning to an ideal one determined by specifications of the vehicle (front:rear=6:4, for example). This problem is solved by the setting of the upper limit of regenerative braking force in this embodiment. Motor generator MG, inverter INV, battery BATT, and motor control unit MCU constitute a regenerative braking system for producing a regenerative torque at left and right rear road wheels RL, RR. Drive controller 1 receives information from various sensors, and performs various control operations depending on the received information, wherein the control operations include a control operation of controlling operation of an automatic transmission not shown, and a control operation of controlling operation of motor generator MG by outputting a drive command to motor control unit MCU.

Brake control unit BCU receives input of information from various sensors directly or through the communication line 2. The sensors include a master cylinder pressure sensor 5 for obtaining and providing information about master cylinder pressure, and a brake pedal stroke sensor 6 as a braking operation detecting section for obtaining and providing information about brake pedal stroke, and a steering wheel angle sensor 7 for obtaining and providing information about steering wheel angle, and a road wheel speed sensor 3 for obtaining and providing information about road wheel speeds, and a yaw rate sensor 8 for obtaining and providing information about vehicle body yaw rate, and a wheel cylinder pressure sensor 9 for obtaining and providing information about wheel cylinder pressure. Brake control unit BCU also receives input of information about battery SOC, etc., through the communication line 2.

Brake control unit BCU is configured to calculate or estimate a driver request value of braking force, based on information about master cylinder pressure and brake pedal stroke. Brake control unit BCU allocates the driver request value of braking force to a component of regenerative braking force and a component of frictional braking force, and controls operation of hydraulic pressure control unit HU to achieve a desired frictional braking force, and outputs a command signal to motor control unit MCU to control operation of motor generator MG to achieve a desired regenerative braking force.

In the present embodiment, a cooperative regenerative braking control is performed in which regenerative braking is prioritized higher than frictional braking so that if a driver request of braking force can be fulfilled by regenerative braking force, brake control unit BCU uses regenerative braking force only, as long as the driver requests is below the upper limit of regenerative braking force. This serves to enhance energy recovery efficiency overall from a low speed region to a high sped region, especially when the vehicle accelerates and decelerates repeatedly. When the vehicle speed decreases or increases so that the regenerative braking force is limited to the upper limit, brake control unit BCU decreases the distribution for regenerative braking force and increases the distribution for frictional braking force, for achieving the driver request. On the other hand, when the upper limit of regenerative braking force is raised to allow a relatively large regenerative braking force, brake control unit BCU increases the distribution for regenerative braking force and decreases the distribution for frictional braking force.

<Hydraulic Circuit> The following describes specific configuration of hydraulic pressure control unit HU. Hydraulic pressure control unit HU has an X-line arrangement including a P-line section and a S-line section. The P-line section is hydraulically connected to left front wheel cylinder W/C(FL) and right rear wheel cylinder W/C(RR), whereas the S-line section is hydraulically connected to right front wheel cylinder W/C(FR) and left rear wheel cylinder W/C(RL). This X-line arrangement allows one of the P-line section and the S-line section to produce half braking force as compared to normal conditions, even when the other of the P-line section and the S-line section is failed. In FIG. 2, each reference symbol having a last character of “P” represents an element associated with the P-line section, whereas each reference symbol having a last character of “S” represents an element associated with the S-line section. Similarly, each reference symbol having last two characters of “FL” represents an element associated with left front road wheel FL, and each reference symbol having last two characters of “FR” represents an element associated with right front road wheel FR, and each reference symbol having last two characters of “RL” represents an element associated with left rear road wheel RL, and each reference symbol having last two characters of “RR” represents an element associated with right rear road wheel RR. In the following description, these last characters are omitted if the described feature is common between the P-line section and S-line section or among road wheels FL, FR, RL and RR for conciseness of the description.

Hydraulic pressure control unit HU employs a closed hydraulic circuit, which is a hydraulic circuit in which brake fluid supplied to wheel cylinder W/C is returned to reservoir tank RSV through master cylinder M/C. Incidentally, in contrast to such a closed type hydraulic circuit, an open type hydraulic circuit is a hydraulic circuit in which brake fluid supplied to a wheel cylinder can be returned directly to a reservoir tank without passing through a master cylinder. Brake pedal BP is coupled to master cylinder M/C through an input rod IR.

The P-line section is provided with a first pump PP1 and a second pump PP2, whereas the S-line section is provided with a first pump PS1 and a second pump PS2. Each pump PP1, PS1, PP2, PS2 is a gear pump in this example. Pumps PP1 and PS1 are driven by a common first electric motor M1, whereas pumps PS1 and PS2 are driven by a common second electric motor M2.

Master cylinder M/C and each wheel cylinder W/C are connected to each other through a fluid passage 11 and a fluid passage 12. Fluid passage 12P braches into a fluid passage 12FL and fluid passage 12RR, wherein fluid passage 12FL is hydraulically connected to left front wheel cylinder W/C(FL), and fluid passage 12RR is hydraulically connected to right rear wheel cylinder W/C(RR). On the other hand, fluid passage 12S braches into a fluid passage 12FR and fluid passage 12RL, wherein fluid passage 12FR is hydraulically connected to right front wheel cylinder W/C(FR), and fluid passage 12RL is hydraulically connected to left rear wheel cylinder W/C(RL). Fluid passage 11 and fluid passage 12 constitute a first brake fluid passage. The connecting point between fluid passage 11 and fluid passage 12 is provided with wheel cylinder pressure sensor 9.

Fluid passage 11 is provided with a gate-out valve 13 therein, which is a normally open proportional electromagnetic valve. The p-line fluid passage 11P is provided with master cylinder pressure sensor 5 therein, which is arranged between master cylinder M/C and gate-out valve 13P. Fluid passage 11 is provided with a fluid passage 14, wherein fluid passage 14 and gate-out valve 13 arranged in parallel. Fluid passage 14 is provided with a check valve 15 therein. Check valve 15 is a unidirectional valve that permits brake fluid to flow in a direction from master cylinder M/C to wheel cylinder W/C, and prevents brake fluid from inversely flowing.

Fluid passage 12 is provided with a solenoid in-valve (solenoid valve or inflow valve) 16 therein, which is a normally open proportional electromagnetic valve corresponding to each wheel cylinder W/C. Fluid passage 12 is also provided with a fluid passage 17, wherein solenoid in-valve 16 and fluid passage 17 are arranged in parallel. Fluid passage 17 is provided with a check valve 18 therein, which permits brake fluid to flow in a direction from wheel cylinder W/C to master cylinder M/C, and prevents brake fluid from inversely flowing.

The connecting point between fluid passage 11 and fluid passage 12 is connected to a fluid discharge port of first pump P1 (first pump PP1 or PS1) by a fluid passage 19. Fluid passage 19 constitutes a second brake fluid passage. Fluid passage 19 is provided with a discharge-side valve 20 therein. Discharge-side valve 20 permits brake fluid to flow in a direction from the discharge port of first pump P1 to fluid passage 11 and fluid passage 12, and prevents brake fluid from inversely flowing.

The suction port of first pump P1 is connected to a point of fluid passage 11 between master cylinder M/C and gate-out valve 13 by a fluid passage 21. Fluid passage 21 constitutes a third brake fluid passage. Fluid passage 21 is provided with a check valve (or switching valve, or unidirectional valve, or pressure regulator valve) 22 therein. Check valve 22 permits brake fluid to flow in a direction from fluid passage 11 to the suction port of first pump P1, and prevents brake fluid from inversely flowing. Moreover, in response to a condition that a driver depresses brake pedal BP so that the internal pressure of fluid passage 21 is raised to exceed a preset threshold, check valve 22 prevents brake fluid from flowing into the suction port of first pump P1, and thereby prevents the suction port of first pump P1 from being subject to high pressure. On the other hand, regardless of the internal pressure of fluid passage 21, check valve 22 opens and allows brake fluid to flow into the suction port of first pump P1, in response to a condition that first pump P1 operates so that the internal pressure of the suction side of first pump P1 falls to be low.

The section of fluid passage 21 between master cylinder M/C and check valve 22 (i.e. upstream with respect to check valve 22) is connected to a section of fluid passage 12 between solenoid in-valves 16 and gate-out valve 13 by a fluid passage 23, a fluid passage 24, and a fluid passage 25. Fluid passages 23, 24, 25 constitute a fourth brake fluid passage. The connecting point between fluid passage 23 and fluid passage 24 is provided with a pressure regulator reservoir 26 therein. The connecting point of fluid passage 24 and fluid passage 25 is provided with second pump P2 (second pump PP2 or PS2) therein.

Fluid passage 25 is provided with a discharge-side valve 27 therein. Discharge-side valve 27 permits brake fluid to flow in a direction from second pump P2 to fluid passage 12, and prevents brake fluid from inversely flowing. Pressure regulator reservoir 26 is connected to a section of fluid passage 12 between solenoid in-valve 16 and wheel cylinder W/C by a fluid passage 28. Fluid passage 28 constitutes a fifth brake fluid passage. Fluid passage 28P branches into a fluid passage 28FL and a fluid passage 28RR, wherein fluid passage 28FL is connected to left front wheel cylinder W/C(FL), and fluid passage 28RR is connected to right rear wheel cylinder W/C(RR). Similarly, fluid passage 28S branches into a fluid passage 28FR and a fluid passage 28RL, wherein fluid passage 28FR is connected to right front wheel cylinder W/C(FR), and fluid passage 28RL is connected to left rear wheel cylinder W/C(RL). Fluid passage 28 is provided with a solenoid out-valve 29 therein, which is a normally closed electromagnetic valve.

Pressure regulator reservoir 26 is provided with a check valve 30 of a pressure-sensitive type. In response to a condition that the quantity of brake fluid stored in pressure regulator reservoir 26 is above a preset threshold or the internal pressure of fluid passage 23 is above a preset threshold, check valve 30 prevents brake fluid from flowing into pressure regulator reservoir 26, and thereby prevents the suction port of second pump P2 from being subject to high pressure. On the other hand, regardless of the internal pressure of fluid passage 23, check valve 30 opens and allows brake fluid to flow into pressure regulator reservoir 26, in response to a condition that second pump P2 operates so that the internal pressure of fluid passage 24 falls to be low.

Pressure regulator reservoir 26 is provided with a reservoir fluid quantity sensor 27 as a reservoir fluid quantity calculating section for measuring the quantity of brake fluid stored in pressure regulator reservoir 26.

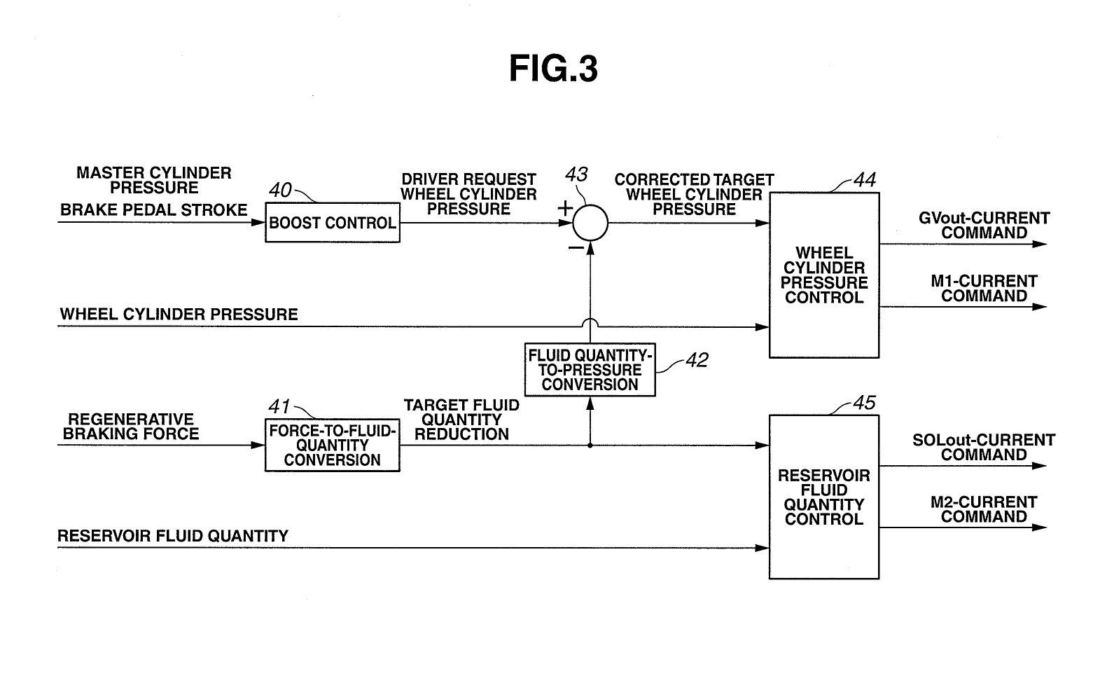

Brake control unit BCU controls the brake fluid pressure by operating the gate-out valves 13, solenoid in-valves 16, solenoid out-valves 29, first electric motor M1, and second electric motor M2, based on the brake pedal stroke measured by brake pedal stroke sensor 6, and the condition of braking regeneration of the regenerative braking system composed of motor generator MG, inverter INV and battery BATT. Brake control unit BCU performs PWM-control for gate-out valves 13, solenoid in-valves 16, first electric motor M1, and second electric motor M2, and performs on-off control for solenoid out-valves 29.

<Cooperative Regenerative Braking Control> FIG. 3 shows a function of cooperative regenerative braking control of brake control unit BCU. Brake control unit BCU includes a boost control section 40, a force-to-fluid-quantity converting section 41, a fluid quantity-to-pressure converting section 42, a target wheel cylinder pressure calculating section 43, a wheel cylinder pressure control section 44 and a reservoir fluid quantity control section 45. Boost control section 40 is configured to calculate a driver request braking force (i.e. a driver request value of braking force) based on the measured master cylinder pressure and brake pedal stroke, and calculate a driver request wheel cylinder pressure (i.e. a driver request value of wheel cylinder pressure) of each wheel cylinder based on the calculated driver request braking force, wherein the driver request wheel cylinder pressure is equivalent to the driver request braking force so that the driver request braking force is achieved with the driver request wheel cylinder pressure of each wheel cylinder. Force-to-fluid-quantity converting section 41 is configured to convert a target or actual value of regenerative braking force to an equivalent fluid quantity of brake fluid in wheel cylinder W/C as a target value of fluid quantity reduction. Fluid quantity-to-pressure converting section 42 is configured to calculate and output a corrected value of target wheel cylinder pressure by subtracting a component of target value of fluid quantity reduction from the driver request wheel cylinder pressure. Wheel cylinder pressure control section 44 is configured to conform the wheel cylinder pressure to the corrected target wheel cylinder pressure by feedback control with feedback of measured wheel cylinder pressure, thereby outputting current command signals (GVout current command, M1 current command) to gate-out valves 13 and first electric motor M1. Reservoir fluid quantity control section 45 is configured to conform the quantity of brake fluid stored in each pressure regulator reservoir 26 to the target value of fluid quantity reduction by feedback control with feedback of measured reservoir fluid quantity, thereby outputting current command signals (SOLout current command, M2 current command) to solenoid out-valves 29 and second electric motor M2.

The following describes how hydraulic pressure control unit HU operates and brake fluid flows in the hydraulic circuit in various situations of regenerative braking control operation.

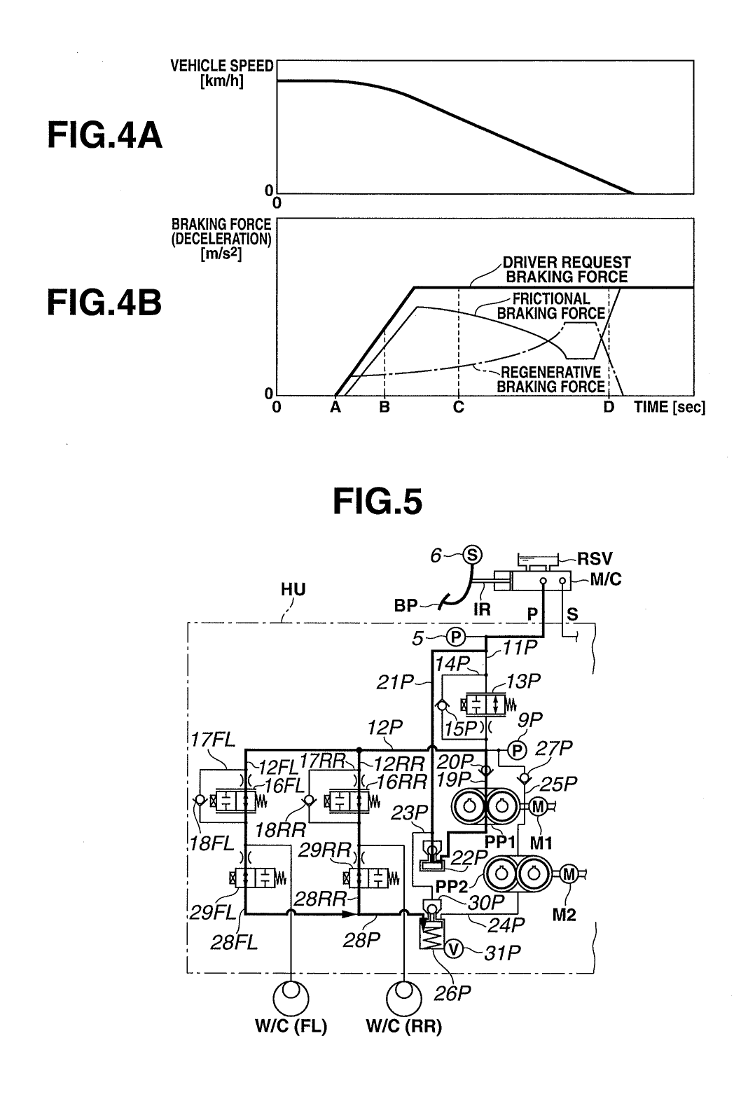

FIGS. 4A and 4B show how three kinds of braking force (driver request braking force, regenerative braking force and frictional braking force) change with time during a period of time from a time instant when the vehicle is traveling at high speed (for example, at 100 km/h) and brake pedal BP starts to be depressed down by a driver to a time instant when the vehicle comes to a halt.

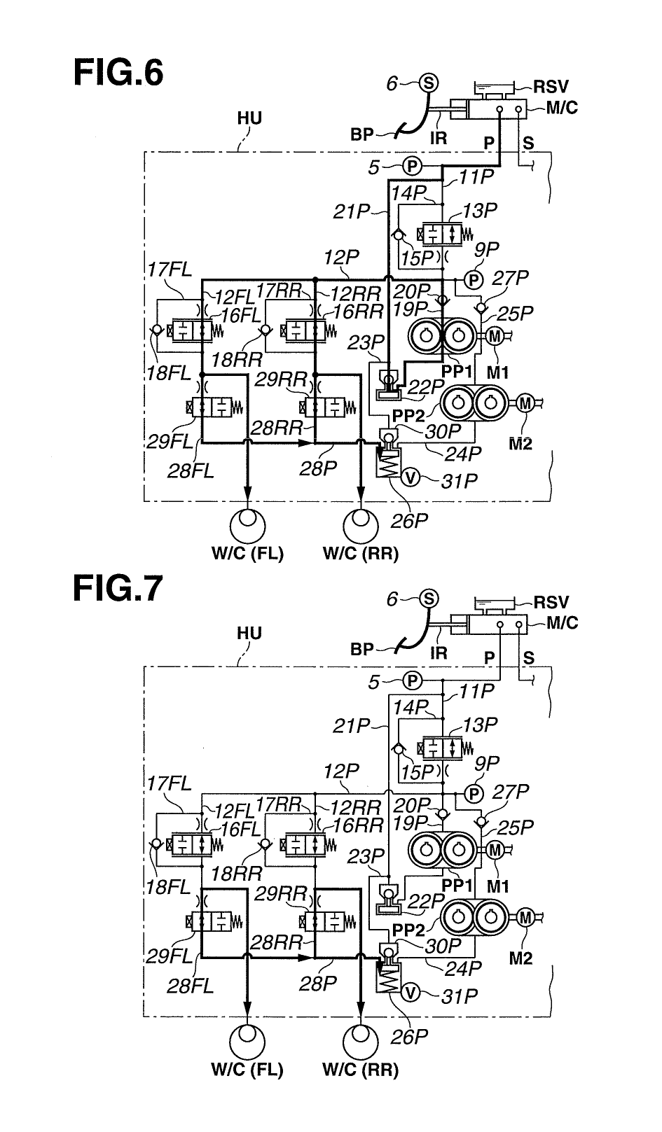

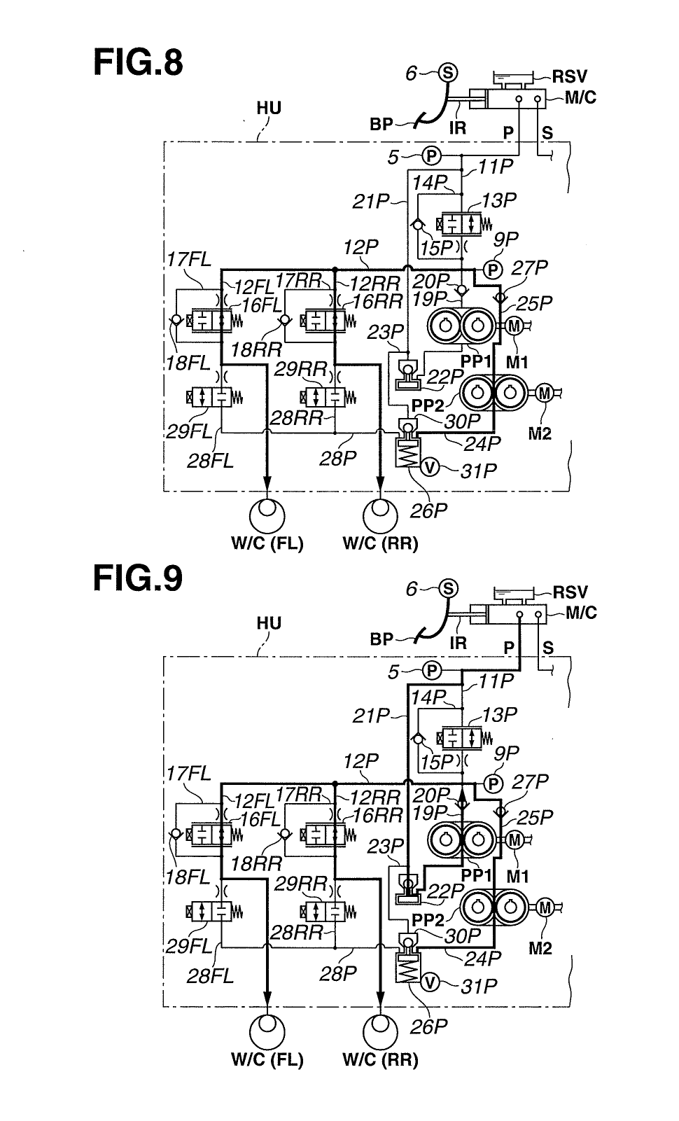

FIGS. 5 to 8 show how hydraulic pressure control unit HU operates and brake fluid flows in the hydraulic circuit in several situations indicated by A, B, C and D in FIG. 4B, which are detailed below. Although FIGS. 5 to 8 are directed to the P-line section, the S-line section operates in the same manner.

<A. At Beginning of Braking Control> FIG. 5 shows how hydraulic pressure control unit HU operates and brake fluid flows in the hydraulic circuit at a beginning of braking operation. At a time instant A where the driver request of braking force starts to rise from zero, brake control unit BCU covers the driver request of braking force only by regenerative braking force. Accordingly, brake control unit BCU operates solenoid out-valves 29 in the opening direction, and allows a quantity of brake fluid to be stored in pressure regulator reservoir 26, to prevent the wheel cylinder pressures from rising, wherein the quantity of brake fluid is equivalent to the magnitude of regenerative braking force. At this moment, brake control unit BCU holds the second electric motor M2 inoperative, because regenerative braking force is increasing. Moreover, brake control unit BCU controls the wheel cylinder pressure to the corrected target wheel cylinder pressure by operating the first electric motor M1 and gate-out valves 13. The feature that the driver request of braking force is fulfilled only by regenerative braking force at start of braking operation serves to enhance the energy recovery efficiency.

<B. At Increase of Braking Force> FIG. 6 shows how hydraulic pressure control unit HU operates and brake fluid flows in the hydraulic circuit at a stage of increase of braking force. At a time instant B where the driver request of braking force is increasing, brake control unit BCU operates solenoid out-valves 29 in the opening direction as the regenerative braking force increases with a decrease in vehicle speed, and allows a quantity of brake fluid to be stored in pressure regulator reservoirs 26, wherein the quantity of brake fluid is equivalent to the magnitude of regenerative braking force. At this moment, brake control unit BCU holds the second electric motor M2 inoperative, because regenerative braking force is increasing. Moreover, brake control unit BCU controls the wheel cylinder pressure to the corrected target wheel cylinder pressure by operating the first electric motor M1 and gate-out valves 13. In this way, brake control unit BCU satisfies the driver request of braking force by combination of regenerative braking force and frictional braking force.

<C. At Increase of Regenerative Braking Force> FIG. 7 shows how hydraulic pressure control unit HU operates and brake fluid flows in the hydraulic circuit at a stage of increase of regenerative braking force. At a time instant C where the driver request of braking force is held constant, brake control unit BCU operates solenoid out-valves 29 in the opening direction as the regenerative braking force increases with a decrease in vehicle speed, and allows a quantity of brake fluid to be stored in pressure regulator reservoirs 26, wherein the quantity of brake fluid is equivalent to the magnitude of regenerative braking force. As a result, the wheel cylinder pressure is gets equal to the corrected target wheel cylinder pressure. At this moment, brake control unit BCU holds the second electric motor M2 inoperative, because regenerative braking force is increasing. Moreover, brake control unit BCU also holds the first electric motor M1 inoperative, because the driver request of braking force is constant. Incidentally, gate-out valves 13 are operated according to wheel cylinder pressure. In this way, brake control unit BCU achieves the driver request of braking force by combination of regenerative braking force and frictional braking force, while reducing the frictional braking force as the regenerative braking force increases, thereby enhancing the energy recovery efficiency.

<D. At Termination of Regenerative Braking> FIG. 8 shows how hydraulic pressure control unit HU operates and brake fluid flows in the hydraulic circuit at a stage of termination of regenerative braking operation. At a time instant D where the driver request of braking force is held constant, brake control unit BCU operates the second electric motor M2 as the regenerative braking force decreases. As a result, the wheel cylinder pressure gets equal to the corrected target wheel cylinder pressure. Brake control unit BCU de-energizes solenoid out-valves 29, i.e. operates solenoid out-valves 29 in the closing direction, because the regenerative braking force is decreasing. Brake control unit BCU holds the first electric motor M1 inoperative, because the driver request of braking force is held constant. Incidentally, gate-out valves 13 are operated according to wheel cylinder pressure. In this way, brake control unit BCU carries out replacement of regenerative braking force with frictional braking force while satisfying the driver request of braking force.

<At Hard Braking Operation> FIG. 9 is a schematic diagram showing how the hydraulic pressure control unit operates and brake fluid flows in the hydraulic circuit at a stage of hard braking operation. Under this condition, brake control unit BCU operates both of first electric motor M1 and second electric motor M2, to quickly raise the braking force, and thereby satisfy the driver request of braking force. This allows to make compact each of first pumps P1, second pumps P2, first electric motor M1, and second electric motor M2.

The following describes advantageous effects produced by the technical features of the brake control apparatus described above. In the first embodiment, hydraulic pressure control unit HU includes first pumps P1 for pressure increase of wheel cylinders W/C, and second pumps P2 for returning brake fluid from pressure regulator reservoirs 26 to fluid passages 11, 12 connected to master cylinder M/C and wheel cylinders W/C. Hydraulic pressure control unit HU of this embodiment implements a boost function of achieving a desired boost ratio by setting the driver request wheel cylinder pressure above the master cylinder pressure, and actively increasing the brake fluid pressure by operating the first pumps P1 and suitably operating the gate-out valves 13 in the opening direction, to conform the wheel cylinder pressure to the driver request wheel cylinder pressure (or the corrected target wheel cylinder pressure after correction in account of regenerative braking when regenerative braking force is outputted).

Hydraulic pressure control unit HU of this embodiment contributes to cooperative regenerative braking control by setting the corrected target wheel cylinder pressure by subtracting from the driver request wheel cylinder pressure a component equivalent to the regenerative braking force, and controlling the first pumps P1 and gate-out valves 13 by feedback control to conform the measured value of wheel cylinder pressure obtained by wheel cylinder pressure sensor 9 to the corrected target wheel cylinder pressure, and simultaneously controlling the second pumps P2 and solenoid out-valves 29 to conform the measured value of reservoir fluid quantity obtained by reservoir fluid quantity sensor 27 to the value equivalent to the regenerative braking force.

In this way, the brake control apparatus of this embodiment is capable of implementing a boost function and contributing to a cooperative regenerative braking control system with a simple structure which is advantageous in reducing the manufacturing cost. This allows to provide a brake control apparatus for a small-size hybrid electric vehicle or electric vehicle provided with a cooperative regenerative braking control system but with no negative pressure generating device.

The feature that fluid passage 21 is provided with check valve 22 for permitting brake fluid to flow from fluid passage 11 to first pump P1, and fluid passage 23 branches from a section of fluid passage 21 upstream of check valve 22, serves to suppress the suction port of first pump P1 from being subject to high pressure when brake pedal BP is depressed by a driver, and thereby enhance the endurance of first pump P1.

The first fluid passage composed of fluid passages 11 and 12 is provided with gate-out valve 13 and solenoid in-valve 16, wherein gate-out valve 13 is disposed between master cylinder M/C and a point of fluid passage 11 connected to fluid passage 21, and wherein solenoid in-valve 16 is disposed between wheel cylinder W/C and gate-out valve 13, and fluid passage 28 is provided to connect wheel cylinder W/C and pressure regulator reservoir 26, and solenoid out-valve 29 is provided in fluid passage 28. Namely, hydraulic pressure control unit HU is regarded as being composed of a basic hydraulic pressure control unit and an additional set of three sensors and first pump P1, wherein the basic hydraulic pressure control unit is capable of performing a typical ABS (antilock braking system) control and a typical vehicle dynamic behavior stabilizing control, and wherein the three sensors are brake pedal stroke sensor 6, wheel cylinder pressure sensor 9, and reservoir fluid quantity sensor 31. This allows to construct hydraulic pressure control unit HU by use of an existing ESC (Electronic Stability Control) unit, and thereby further reduces the manufacturing cost of the brake control apparatus.

Brake control unit BCU controls gate-out valves 13, solenoid in-valves 16, solenoid out-valves 29, first electric motor M1, and second electric motor M2, depending on the brake pedal stroke and reservoir fluid quantity, based on information from brake pedal stroke sensor 6, reservoir fluid quantity sensor 31, first electric motor M1, and second electric motor M2. This feature serves to output an optimal frictional braking force according to brake pedal stroke and reservoir fluid quantity.

Brake control unit BCU serves as a brake feel producing section to send a quantity of brake fluid under pressure to pressure regulator reservoir 26 by operating the gate-out valves 13 in the closing direction, operating the solenoid out-valves 29 in the opening direction, and operating the first electric motor M1, wherein the quantity of brake fluid is flown out of master cylinder M/C according to driver's braking operation. This serves to ensure a suitable amount of brake pedal stroke and pedal force during cooperative regenerative braking control, and thereby achieve a suitable brake feel (or brake reaction).

Brake control unit BCU serves as a cooperative regenerative braking control section to send a quantity of brake fluid under pressure to pressure regulator reservoir 26 and wheel cylinders W/C by operating the gate-out valves 13 in the closing direction, operating the solenoid out-valves 29 in the closing direction, and operating the first electric motor M1, wherein the quantity of brake fluid is flown out of master cylinder M/C according to driver's braking operation. This serves to satisfy the driver request of braking force by combination of regenerative braking force and frictional braking force.

Brake control unit BCU serves as a wheel cylinder pressure reduction control section to allow a quantity of brake fluid to flow from wheel cylinders W/C to pressure regulator reservoirs 26 by operating the solenoid out-valves 29 in the opening direction. This serves to reduce the frictional braking force in response to increase of regenerative braking force, and thereby enhance the energy recovery efficiency while satisfying the driver request of braking force.

Brake control unit BCU serves as a wheel cylinder pressure increase control section to send a quantity of brake fluid under pressure from pressure regulator reservoirs 26 to wheel cylinders W/C by operating the solenoid out-valves 29 in the closing direction, and operating the second electric motor M2. This serves to increase the frictional braking force in response to decrease of regenerative braking force, and thereby satisfy the driver request of braking force.

Brake control unit BCU serves as a hard braking control section to raise the wheel cylinder pressures by operating both of first electric motor M1 and second electric motor M2. This serves to quickly increase the braking force, and thereby satisfy the driver request of braking force during hard braking.

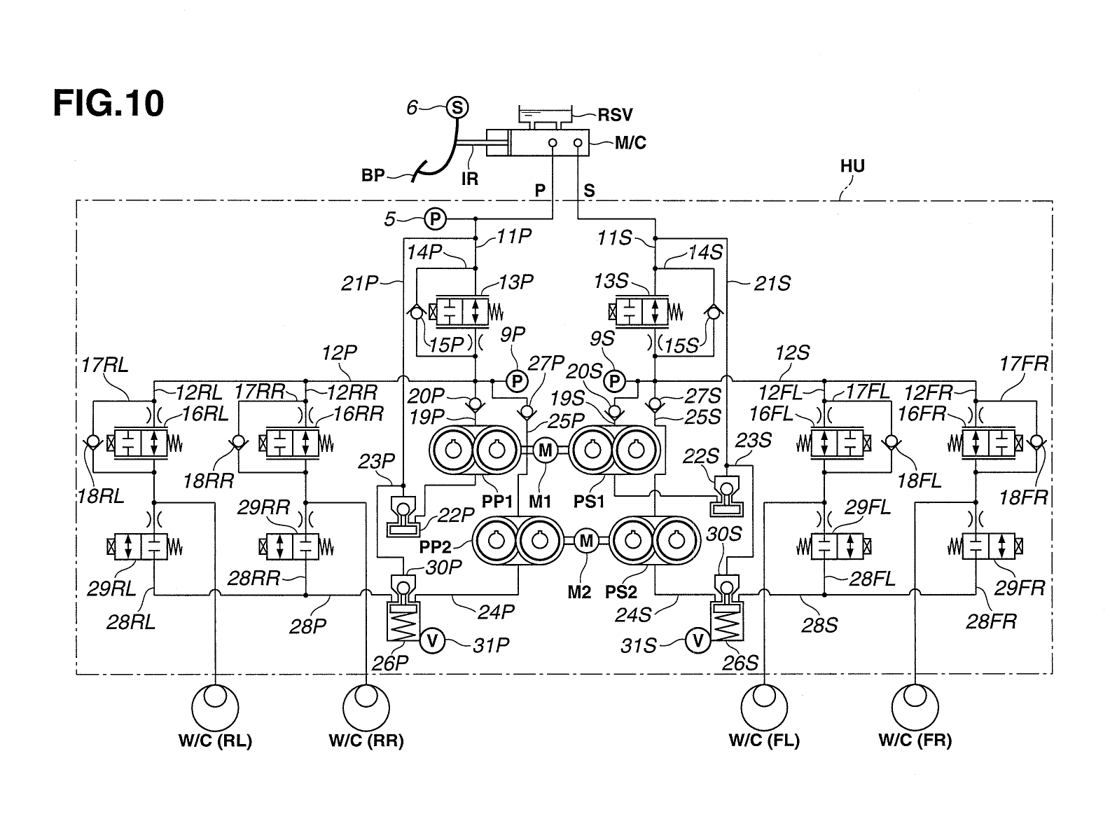

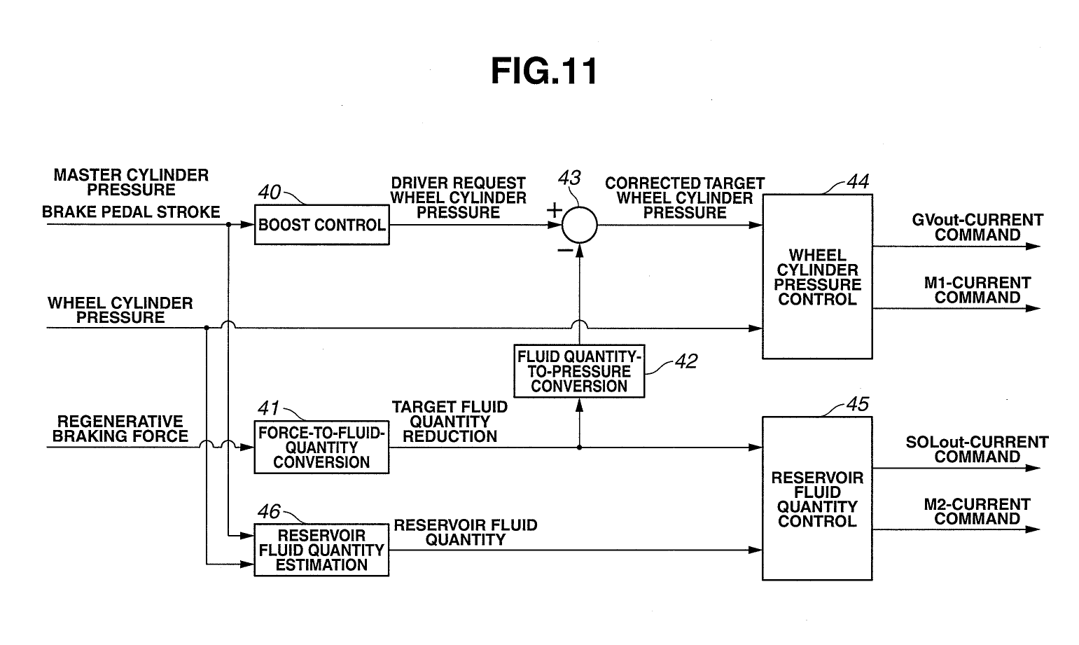

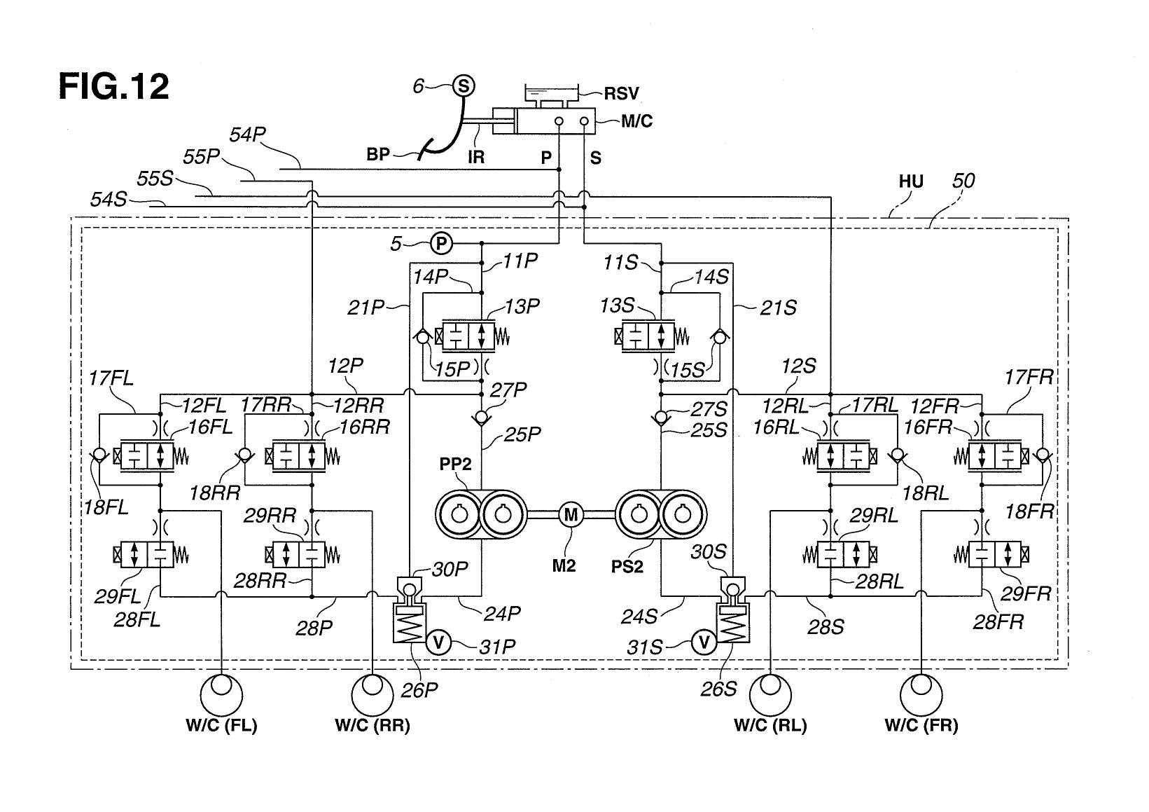

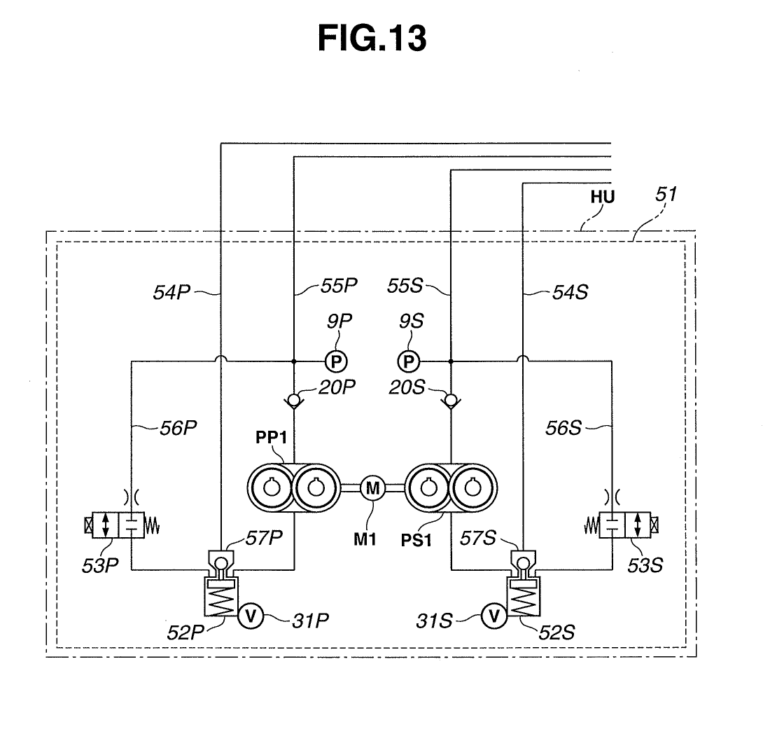

The following summarizes the technical features of the brake control apparatus described above, and advantageous effects produced by the brake control apparatus.

<1> A brake control apparatus includes: a first brake fluid passage (fluid passages 11, 12) hydraulically connecting a master cylinder (M/C) to a wheel cylinder (W/C), wherein the master cylinder (M/C) generates a brake fluid pressure in response to driver's braking operation, and wherein the brake fluid pressure acts on the wheel cylinder (W/C); a second brake fluid passage (fluid passage 19) hydraulically connected to a connecting portion of the first brake fluid passage (11, 12); a first pump (P1) configured to pressurize brake fluid from the master cylinder (M/C) and send the pressurized brake fluid to the wheel cylinder (W/C) through the second brake fluid passage (19); a third brake fluid passage (fluid passage 21) branched from a branch portion of the first brake fluid passage (11, 12), and hydraulically connected to the first pump (P1); a fourth brake fluid passage (fluid passages 23, 24, 25) branched from a branch portion of the third brake fluid passage (21), and hydraulically connected to the first brake fluid passage (11, 12); a pressure regulator reservoir (26) disposed in the fourth brake fluid passage (23, 24, 25); and a second pump (P2) configured to send brake fluid from the pressure regulator reservoir (26) to the wheel cylinder (W/C) by discharging to the first brake fluid passage (11, 12). This feature serves to achieve a boost function and conform to cooperative regenerative braking based on pump operation, with a simple structure for cost reduction.

<2> The brake control apparatus further includes a switching valve (check valve 22) disposed in the third brake fluid passage (21), and configured to allow brake fluid to flow from the first brake fluid passage (11, 12) to the first pump (P1), wherein the branch portion of the third brake fluid passage (21) from which the fourth brake fluid passage (23, 24, 25) is branched is disposed between the switching valve (22) and the branch portion of the first brake fluid passage (11, 12) from which the third brake fluid passage (21) is branched. The switching valve (check valve 22) prevents brake fluid flow from the third brake fluid passage (fluid passage 21) to the first pump (P1) when the internal pressure of the third brake fluid passage (fluid passage 21) is high, and permits the brake fluid flow when the internal pressure of the third brake fluid passage (fluid passage 21) is low and when the first pump (P1) is operating. This feature serves to prevent the suction side of the first pump (P1) from being subject to high pressure when brake pedal BP is depressed by a driver, and thereby enhance the endurance of the first pump (P1).

<3> The brake control apparatus further includes a unidirectional valve (check valve 22) disposed in the third brake fluid passage (21), and configured to allow brake fluid to flow from the first brake fluid passage (11, 12) to the first pump (P1), wherein the branch portion of the third brake fluid passage (21) from which the fourth brake fluid passage (23, 24, 25) is branched is disposed between the unidirectional valve (22) and the branch portion of the first brake fluid passage (11, 12) from which the third brake fluid passage (21) is branched. The unidirectional valve (check valve 22) prevents brake fluid flow from the third brake fluid passage (fluid passage 21) to the first pump (P1) when the internal pressure of the third brake fluid passage (fluid passage 21) is high, and permits the brake fluid flow when the internal pressure of the third brake fluid passage (fluid passage 21) is low and when the first pump (P1) is operating. This feature serves to prevent the suction side of the first pump (P1) from being subject to high pressure when brake pedal BP is depressed by a driver, and thereby enhance the endurance of the first pump (P1).

<4> The brake control apparatus further includes: a gate-out valve (13) disposed in a section of the first brake fluid passage (11, 12) between the master cylinder (M/C) and the connecting portion of the first brake fluid passage (11, 12) from which the second brake fluid passage (19) is hydraulically connected, wherein the gate-out valve (13) is a normally open valve; a solenoid in-valve (16) disposed in a section of the first brake fluid passage (11, 12) between the wheel cylinder (W/C) and the gate-out valve (13), wherein the solenoid in-valve (16) is a normally open valve; a fifth brake fluid passage (28) hydraulically connecting the wheel cylinder (W/C) to the pressure regulator reservoir (26); and a solenoid out-valve (29) disposed in the fifth brake fluid passage (28), wherein the solenoid out-valve (29) is a normally closed valve. This feature allows to construct the brake control apparatus based on an existing ESC unit, and thereby reduce the manufacturing cost.

<5> The brake control apparatus further includes: a braking operation detecting section (brake pedal stroke sensor 6) configured to detect a condition of driver's braking operation (brake pedal stroke) for a vehicle provided with a regenerative braking system (motor generator MG, inverter INV, battery BATT); a regenerative braking operation detecting section (reservoir fluid quantity sensor 31) configured to detect a condition of regenerative braking operation (reservoir fluid quantity) of the regenerative braking system (MG, INV, BATT); a first motor (first electric motor M1) configured to drive the first pump (P1); a second motor (second electric motor M2) configured to drive the second pump (P2); and a control unit (brake control unit BCU) configured to control the gate-out valve (13), the solenoid in-valve (16), the solenoid out-valve (29), the first motor (M1), and the second motor (M2), based on the detected condition of driver's braking operation and the detected condition of regenerative braking operation. This feature serves to output an optimal frictional braking force in conformance with the detected condition of driver's braking operation (brake pedal stroke) and the detected condition of regenerative braking operation (reservoir fluid quantity) of the regenerative braking system (MG, INV, BATT).

<Second Embodiment> FIG. 10 shows a hydraulic circuit of a brake control apparatus according to a second embodiment of the present invention. The second embodiment differs from the first embodiment in that hydraulic pressure control unit HU is based on the so-called H-line arrangement instead of X-line arrangement. Specifically, hydraulic pressure control unit HU includes a P-line section and a S-line section, wherein left front road wheel FL and right front road wheel FR belong to the P-line section, and left rear road wheel RL and right rear road wheel RR belong to the S-line section. Except for those features, the brake control apparatus of the second embodiment is configured similarly as in the first embodiment. This brake control apparatus is advantageous in producing equal braking forces at the left side and the right side when using one of the P-line section and S-line section because of failure of the other. This feature serves to suppress dynamic behavior of the vehicle from falling unstable at braking.

<Third embodiment> FIG. 11 shows a function of cooperative regenerative braking control of a brake control unit of a brake control apparatus according to a third embodiment of the present invention. This brake control unit BCU differs from that of the first embodiment in that brake control unit BCU includes a reservoir fluid quantity estimating section 46 for estimating the quantity of brake fluid stored in pressure regulator reservoir 26. Reservoir fluid quantity estimating section 46 is configured to calculate an estimated value of the quantity of brake fluid stored in pressure regulator reservoir 26, based on master cylinder pressure, brake pedal stroke, and wheel cylinder pressure. It is because hydraulic pressure control unit HU is based on a closed hydraulic circuit that this estimation can be suitably performed. The ability of estimating the reservoir fluid quantity without sensor information allows to further reduce the manufacturing cost.

<Fourth embodiment> FIGS. 12 and 13 show a hydraulic circuit of a brake control apparatus according to a fourth embodiment of the present invention. Hydraulic pressure control unit HU according to the fourth embodiment differs from that of the first embodiment in that hydraulic pressure control unit HU is composed of two separate units, namely, an ESC unit 50 and a regenerative braking cooperation unit 51, wherein the ESC unit 50 is capable of performing a common ABS control and a common vehicle dynamic behavior stabilizing control. In ESC unit 50, when the quantity of brake fluid stored in pressure regulator reservoir 26 has reached a specific level, and when the internal pressure of fluid passage 21 is above a predetermined threshold, check valve 30 of pressure regulator reservoir 26 prevents brake fluid from flowing into pressure regulator reservoir 26, and thereby prevents the suction port of second pump P2 from being subject to high pressure. When second pump P2 operates so that the internal pressure of fluid passage 24 falls to be low, check valve 30 opens to allow brake fluid to flow into pressure regulator reservoir 26, regardless of the internal pressure of fluid passage 21.

In regenerative braking cooperation unit 51, brake fluid is supplied from fluid passage 11 through fluid passage 54 into a pressure regulator reservoir 52. The brake fluid stored in pressure regulator reservoir 52 is supplied to and then pressurized by first pump P1, and then discharged to fluid passage 12 through a fluid passage 55. Fluid passage 55 is connected to a fluid passage 56 connected to pressure regulator reservoir 52. Fluid passage 56 is provided with a shutoff valve 53 therein, which is a normally closed electromagnetic valve.

Pressure regulator reservoir 52 is provided with a check valve 57 of a pressure-sensitive type. When the quantity of brake fluid stored in pressure regulator reservoir 52 has reached a specific level, and when the internal pressure of fluid passage 54 is above a predetermined threshold, check valve 57 prevents brake fluid from flowing into pressure regulator reservoir 52, and thereby prevents the suction port of first pump P1 from being subject to high pressure. When first pump P1 operates so that the internal pressure of the suction side of first pump P1 falls to be low, check valve 57 opens to allow brake fluid to flow into pressure regulator reservoir 52, regardless of the internal pressure of fluid passage 54. Reservoir fluid quantity sensor 31 is configured to measure the quantity of brake fluid stored in pressure regulator reservoir 52.

In this way, hydraulic pressure control unit HU according to the fourth embodiment can be constructed by adding the regenerative braking cooperation unit 51 to the existing ESC unit 50. Accordingly, vehicles such as hybrid electric vehicles and electric vehicles provided with a regenerative braking system, and vehicles provided with no such regenerative braking system can share a common part of hydraulic pressure control unit HU (namely, ESC unit 50). This serves to further reduce the manufacturing cost.

<Modifications> The present embodiments may be modified variously. For example, although the first embodiment is an example applied to an electric hybrid vehicle, the brake control apparatus described above may be applied to any other vehicle provided with a regenerative braking system, such as electric vehicles, for producing similar advantageous effects as in the present embodiments. Although all of the driver request braking force, regenerative braking force, and frictional braking force are determined by brake control unit BCU in the foregoing embodiments, the driver request braking force and regenerative braking force may be determined and sent to brake control unit BCU by another control unit.

The entire contents of Japanese Patent Application 2012-039508 filed Feb. 27, 2012 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake control apparatus comprising:
a first brake fluid passage hydraulically connecting a master cylinder to a wheel cylinder, wherein the master cylinder generates a brake fluid pressure in response to driver's braking operation, and wherein the brake fluid pressure acts on the wheel cylinder;
a second brake fluid passage hydraulically connected to a connecting portion of the first brake fluid passage;
a first pump configured to pressurize brake fluid from the master cylinder and send the pressurized brake fluid to the wheel cylinder through the second brake fluid passage;
a third brake fluid passage branched from a branch portion of the first brake fluid passage, and hydraulically connected to the first pump;
a fourth brake fluid passage branched from a branch portion of the third brake fluid passage, and hydraulically connected to the first brake fluid passage;
a pressure regulator reservoir disposed in the fourth brake fluid passage; and
a second pump configured to send brake fluid from the pressure regulator reservoir to the wheel cylinder by discharging to the first brake fluid passage.

2. The brake control apparatus as claimed in claim 1, further comprising a switching valve disposed in the third brake fluid passage, and configured to allow brake fluid to flow from the first brake fluid passage to the first pump, wherein the branch portion of the third brake fluid passage from which the fourth brake fluid passage is branched is disposed between the switching valve and the branch portion of the first brake fluid passage from which the third brake fluid passage is branched.

3. The brake control apparatus as claimed in claim 1, further comprising a unidirectional valve disposed in the third brake fluid passage, and configured to allow brake fluid to flow from the first brake fluid passage to the first pump, wherein the branch portion of the third brake fluid passage from which the fourth brake fluid passage is branched is disposed between the unidirectional valve and the branch portion of the first brake fluid passage from which the third brake fluid passage is branched.

4. The brake control apparatus as claimed in claim 3, further comprising:
a gate-out valve disposed in a section of the first brake fluid passage between the master cylinder and the connecting portion of the first brake fluid passage from which the second brake fluid passage is hydraulically connected, wherein the gate-out valve is a normally open valve;
a solenoid in-valve disposed in a section of the first brake fluid passage between the wheel cylinder and the gate-out valve, wherein the solenoid in-valve is a normally open valve;
a fifth brake fluid passage hydraulically connecting the wheel cylinder to the pressure regulator reservoir; and
a solenoid out-valve disposed in the fifth brake fluid passage, wherein the solenoid out-valve is a normally closed valve.

5. The brake control apparatus as claimed in claim 4, further comprising:
a braking operation detecting section configured to detect a condition of driver's braking operation for a vehicle provided with a regenerative braking system;
a regenerative braking operation detecting section configured to detect a condition of regenerative braking operation of the regenerative braking system;
a first motor configured to drive the first pump;
a second motor configured to drive the second pump; and
a control unit configured to control the gate-out valve, the solenoid in-valve, the solenoid out-valve, the first motor, and the second motor, based on the detected condition of driver's braking operation and the detected condition of regenerative braking operation.

6. The brake control apparatus as claimed in claim 5, wherein the control unit includes a brake feel producing section configured to send a quantity of brake fluid under pressure to the pressure regulator reservoir by operating the gate-out valve in a closing direction, operating the solenoid out-valve in an opening direction, and driving the first motor, wherein the quantity of brake fluid is flown out of the master cylinder by driver's braking operation.

7. The brake control apparatus as claimed in claim 5, wherein the control unit includes a cooperative regenerative braking control section configured to send a quantity of brake fluid under pressure to the pressure regulator reservoir and the wheel cylinder by operating the gate-out valve in a closing direction, operating the solenoid out-valve in a closing direction, and driving the first motor, wherein the quantity of brake fluid is flown out of the master cylinder by driver's braking operation.

8. The brake control apparatus as claimed in claim 7, wherein the control unit includes a wheel cylinder pressure reduction control section configured to allow brake fluid to flow out from the wheel cylinder to the pressure regulator reservoir by operating the solenoid out-valve in an opening direction.

9. The brake control apparatus as claimed in claim 8, wherein the control unit includes a wheel cylinder pressure increase control section configured to send brake fluid under pressure from the pressure regulator reservoir to the wheel cylinder by operating the solenoid out-valve in a closing direction and driving the second motor.

10. The brake control apparatus as claimed in claim 5, wherein the control unit includes a wheel cylinder pressure quick increase control section configured to pressurize the wheel cylinder by driving the first motor and driving the second motor.

11. A brake control apparatus for a vehicle provided with a regenerative braking system, the brake control apparatus comprising:
a braking operation detecting section configured to detect a condition of driver's braking operation;
a regenerative braking operation detecting section configured to detect a condition of regenerative braking operation of the regenerative braking system;
a first brake fluid passage hydraulically connecting a master cylinder to a wheel cylinder;
a second brake fluid passage hydraulically connected to a connecting portion of the first brake fluid passage;
a first pump configured to pressurize brake fluid from the master cylinder and send the pressurized brake fluid to the wheel cylinder through the second brake fluid passage;
a third brake fluid passage branched from a branch portion of the first brake fluid passage, and hydraulically connected to a suction side of the first pump;
a fourth brake fluid passage branched from a branch portion of the third brake fluid passage, and hydraulically connected to the first brake fluid passage;
a pressure regulator reservoir disposed in the fourth brake fluid passage;
a second pump disposed in parallel with the first pump, and configured to discharge brake fluid from the pressure regulator reservoir to the first brake fluid passage; and
a control unit configured to control operation of the first pump and the second pump, based on the detected condition of driver's braking operation and the detected condition of regenerative braking operation.

12. The brake control apparatus as claimed in claim 11, further comprising:
a gate-out valve disposed in a section of the first brake fluid passage between the master cylinder and the connecting portion of the first brake fluid passage from which the second brake fluid passage is hydraulically connected, wherein the gate-out valve is a normally open valve;
a solenoid in-valve disposed in a section of the first brake fluid passage between the wheel cylinder and the gate-out valve, wherein the solenoid in-valve is a normally open valve;
a fifth brake fluid passage hydraulically connecting the wheel cylinder to the pressure regulator reservoir; and
a solenoid out-valve disposed in the fifth brake fluid passage, wherein the solenoid out-valve is a normally closed valve.

13. The brake control apparatus as claimed in claim 12, further comprising a pressure regulator valve disposed in the third brake fluid passage, and configured to shut off brake fluid flow from the first brake fluid passage to the first pump resulting from brake fluid pressure generated by the master cylinder, wherein the branch portion of the third brake fluid passage from which the fourth brake fluid passage is branched is disposed between the pressure regulator valve and the branch portion of the first brake fluid passage from which the third brake fluid passage is branched.

14. The brake control apparatus as claimed in claim 13, further comprising:
a first motor configured to drive the first pump; and
a second motor configured to drive the second pump;
wherein the control unit is configured to control the gate-out valve, the solenoid in-valve, the solenoid out-valve, the first motor, and the second motor.

15. The brake control apparatus as claimed in claim 14, wherein the control unit includes a brake feel producing section configured to send a quantity of brake fluid under pressure to the pressure regulator reservoir by operating the gate-out valve in a closing direction, operating the solenoid out-valve in an opening direction, and driving the first motor, wherein the quantity of brake fluid is flown out of the master cylinder by driver's braking operation.

16. The brake control apparatus as claimed in claim 15, wherein the control unit includes a cooperative regenerative braking control section configured to send a quantity of brake fluid under pressure to the pressure regulator reservoir and the wheel cylinder by operating the gate-out valve in the closing direction, operating the solenoid out-valve in a closing direction, and driving the first motor, wherein the quantity of brake fluid is flown out of the master cylinder by driver's braking operation.

17. The brake control apparatus as claimed in claim 16, wherein the control unit includes a wheel cylinder pressure reduction control section configured to allow brake fluid to flow out from the wheel cylinder to the pressure regulator reservoir by operating the solenoid out-valve in the opening direction.

18. The brake control apparatus as claimed in claim 17, wherein the control unit includes a wheel cylinder pressure increase control section configured to send brake fluid under pressure from the pressure regulator reservoir to the wheel cylinder by operating the solenoid out-valve in the closing direction and driving the second motor.

19. The brake control apparatus as claimed in claim 18, wherein the control unit includes a wheel cylinder pressure quick increase control section configured to pressurize the wheel cylinder by driving the first motor and driving the second motor.

20. A brake control apparatus for a vehicle provided with a regenerative braking system, the brake control apparatus comprising:
a braking operation detecting section configured to detect a condition of driver's braking operation;
a regenerative braking operation detecting section configured to detect a condition of regenerative braking operation of the regenerative braking system;
a first brake fluid passage hydraulically connecting a master cylinder to a wheel cylinder;
a second brake fluid passage hydraulically connected to a connecting portion of the first brake fluid passage;
a first pump configured to pressurize brake fluid from the master cylinder and send the pressurized brake fluid to the wheel cylinder through the second brake fluid passage;
a third brake fluid passage branched from a branch portion of the first brake fluid passage, and hydraulically connected to a suction side of the first pump;
a fourth brake fluid passage branched from a branch portion of the third brake fluid passage, and hydraulically connected to the first brake fluid passage;
a pressure regulator reservoir disposed in the fourth brake fluid passage;
a second pump disposed in parallel with the first pump, and configured to discharge brake fluid from the pressure regulator reservoir to the first brake fluid passage; and
a control unit configured to control operation of the first pump and the second pump, based on the detected condition of driver's braking operation and the detected condition of regenerative braking operation;
wherein the control unit includes:
a hard braking control section configured to pressurize the wheel cylinder by driving the first motor and driving the second motor;
a brake feel producing section configured to produce a brake operation feel by driving the first motor under condition that the regenerative braking system is producing a braking force;
a wheel cylinder pressure reduction control section configured to reduce pressure of the wheel cylinder in response to increase of the braking force produced by the regenerative braking system, without driving the driving the first and second motors; and
a wheel cylinder pressure increase control section configured to pressurize the wheel cylinder by driving the second motor in response to decrease of the braking force produced by the regenerative braking system.
